(19) United States
(12) Patent Application Publication
(10) Pub. No.: US 2010/0001568 A1
(43) Pub. Date: Jan. 7, 2010

(54) VEHICLE SEAT WITH CUSHION CARRIER

(76) Inventors: Dalton Trybus, Rochester Hills, MI (US); Amit Kulkarni, Troy, MI (US)

Correspondence Address: KENYON & KENYON LLP, ONE BROADWAY, NEW YORK, NY, 10004, US

(21) Appl. No.: 12/167,485

(22) Filed: Jul. 3, 2008

(51) Int. Cl. B60N 2/00

(52) U.S. Cl. 297/312; 297/284.1

(57) ABSTRACT

A seat for a vehicle includes a cushion carrier for a bottom seat cushion, the carrier having a frame with a raised front portion and an integrated reinforcement member disposed in an interior space of the front portion, the reinforcement member being rigid and reticulated, the seat also including a molded foam bottom seat cushion disposed above the cushion carrier.

### CROSS-REFERENCE TO RELATED APPLICATIONS

This application is related to U.S. patent application Ser. No. ______, filed on the even date herewith, entitled “VEHICLE SEAT WITH CUSHION CARRIER,” bearing Attorney Docket No. 14572/46701, which is expressly incorporated herein in its entirety by reference thereto.

### FIELD OF THE INVENTION

The present invention relates to a cushion carrier for a seat. In particular, the invention relates to a cushion carrier for a vehicle seat.

### BACKGROUND

Rear vehicle seat cushions are generally made from a wire frame and molded foam that are trimmed together and attached to the vehicle body. These wire frame based seats are typically bulky and do not offer optimal usage of space within a vehicle compartment, e.g., the space below a seat cushion. Moreover, without additional support structure, these seats may be problematic in that they may allow “submarining” during a crash. Submarining occurs when an occupant is thrust forward, e.g., during a frontal crash, and the occupant's lower body slides forward under a lap portion of a seatbelt. In this manner, submarining allows the seatbelt to shift from the bony waist area to the abdomen. This may result in much more severe damage to the occupant, as the force applied by the seatbelt during the crash may damage the vital organs of the abdomen. An additional risk is presented in that a portion of the occupant's lower body, e.g., the knees, may experience an impact due to the forward sliding. It is thus advantageous to reduce the possibility of submarining.

In an attempt to reduce the probability of submarining and to comply with increasingly stringent governmental and non-governmental regulations and standards, automobile manufacturers have introduced additional support to the front the seat in an attempt to dissipate the kinetic energy of the occupant and control undesirable kinematics, such as partial ejection, e.g., from submarining. Increased rigidity at the front of the seat may impede the front of the cushion from compressing and provides resistance to the occupant sliding forward along the seat bottom during a crash. To this end, raised metal supports, e.g., bracings, are incorporated into the automobile body at the front of the seat position. However, incorporating the additional support into the body may result in disadvantages, such as, e.g., reduction of floor design freedom. For example, according to these methods a car platform may need to be designed for a specific car type (e.g., sedans, sport utility vehicles, or minivans), thus eliminating the opportunity of having similar floor configurations between platforms, thereby potentially resulting in additional mass and cost to manufacturers.

Regarding wire frame based seats, the seats may be relatively costly to manufacture, due to, e.g., the need for a substantial amount of foam and the cost in providing the metal wire frame. To reduce the amount of foam and/or to eliminate the wire frame, a plastic cushion carrier may be utilized. However, such carriers may potentially yield and/or break during a collision and may not take full advantage of the useable space in the seat area.

### SUMMARY

According to example embodiments of the present invention, a seat for a vehicle includes a cushion carrier for a bottom seat cushion, the carrier having a frame with a raised front portion and an integrated reinforcement member disposed in an interior space of the front portion, the reinforcement member being rigid and reticulated, e.g., having a series of ribs or a closed geometric shape. The seat also includes a molded foam bottom seat cushion disposed above the cushion carrier. The seat may be suitable for installation as a rear seat of a vehicle. The frame may be molded. The frame may be formed from plastic. The reinforcement member may be formed from the same material as the frame. The reinforcement member may include a plurality of parallel walls. Each wall of the plurality of walls may extend in a transverse direction across the seat. The reinforcement member may include a honeycomb structure. The honeycomb structure may include walls that connect to form a hexagonal cross section. The reinforcement member may be integrally formed with the frame. The seat may not include a wire frame. The reinforcement member may be formed from plastic. The reinforcement member may include a structural foam. The seat may also include a seat cushion covering secured to the seat cushion by attachment to the cushion carrier. The cushion carrier may have a planar bottom surface. The frame may extend to a rear portion of the seat below a seat back portion. The frame may include at least one raised side portion. The seat may have two seating positions in order to accommodate two occupants, where the frame supports both seating positions, and where the frame may be integrally formed as a single piece. The frame may include a raised center portion that extends between the two seating positions.

According to example embodiments of the present invention, a vehicle includes a seat that has a cushion carrier for a bottom seat cushion, the carrier having a frame with a raised front portion and an integrated reinforcement member disposed in an interior space of the front portion, the reinforcement member being rigid and reticulated. The seat also includes a molded foam bottom seat cushion disposed above the cushion carrier. The vehicle may be an automobile. The vehicle may have an automobile frame, where the frame of the cushion carrier is attached directly to the automobile frame.

According to example embodiments of the present invention, a seat for a vehicle includes a cushion carrier for a bottom seat cushion, the carrier having a rigid frame, and a molded foam bottom seat cushion supported by the frame, where at least a portion of the frame is exposed from the bottom seat cushion, the exposed portion having an outwardly facing surface and an inwardly facing surface, the inwardly facing surface facing an interior space of the frame that is unoccupied by the seat cushion. The exposed portion may have a cup holder that projects into the interior space. The cup holder may be integrally formed with the frame. The cushion carrier may have a speaker mounted through the exposed portion, the speaker having wires that extend into the interior portion. The cushion carrier may have an electronic control device mounted through the exposed portion. The control device may control an air conditioning system of the vehicle. The cushion carrier has a lighting device mounted through the exposed portion. The interior space may be accessible for storage. A cushion attachment portion of the frame may be rotatably attached to a base portion of the frame. The interior space may accessible by lifting the cushion attachment portion. A spare tire may be accessible, the spare tire being stored in the interior space. The angle of the bottom seat cushion may be adjustable by adjusting the angle of the cushion attachment portion.

The cushion carrier may have a tray that is slidable through the exposed portion from a closed position to an open position, the tray being at least partially disposed in the interior space when the tray is in the closed position. The exposed surface may be upwardly directed. The exposed surface may be disposed between two bottom seat cushions of two respective seating positions. The frame may be formed from plastic. The bottom seat cushion may not support by a wire frame. The frame may be integrally formed as a single piece. The frame may have a raised front portion, where the cushion carrier has an integrated reinforcement member disposed in the interior space of the front portion, the reinforcement member being rigid and reticulated. The seat may be arranged for installation as a rear seat of a vehicle. The cushion carrier may include a subwoofer arranged to fire into the interior space.

According to example embodiments of the present invention, a vehicle includes a seat having a cushion carrier for a bottom seat cushion, the carrier having a rigid frame, a molded foam bottom seat cushion supported by the frame, where at least a portion of the frame is exposed from the bottom seat cushion, the exposed portion having an outwardly facing surface and an inwardly facing surface, the inwardly facing surface facing an interior space of the frame that is unoccupied by the seat cushion. The vehicle may be an automobile. The vehicle may have an automobile frame, the frame of the cushion carrier being attached directly to the automobile frame.

Additional features and aspects of example embodiments of the present invention are described in more detail below with reference to the appended Figures.

### BRIEF DESCRIPTION OF THE DRAWINGS

FIG. 1 illustrates a seat according to an example embodiment of the present invention.

FIG. 2 is a cross-sectional view of a seat according to an example embodiment of the present invention.

FIG. 3 illustrates a seat according to an example embodiment of the present invention.

FIG. 4 illustrates a seat according to an example embodiment of the present invention.

FIG. 5 illustrates seats according to an example embodiment of the present invention.

FIG. 6 illustrates a portion of a seat according to an example embodiment of the present invention.

FIG. 7 illustrates a front portion of a seat according to an example embodiment of the present invention.

FIG. 8 illustrates a seat according to an example embodiment of the present invention.

FIG. 9 illustrates an adjustable seat according to an example embodiment of the present invention.

### DETAILED DESCRIPTION

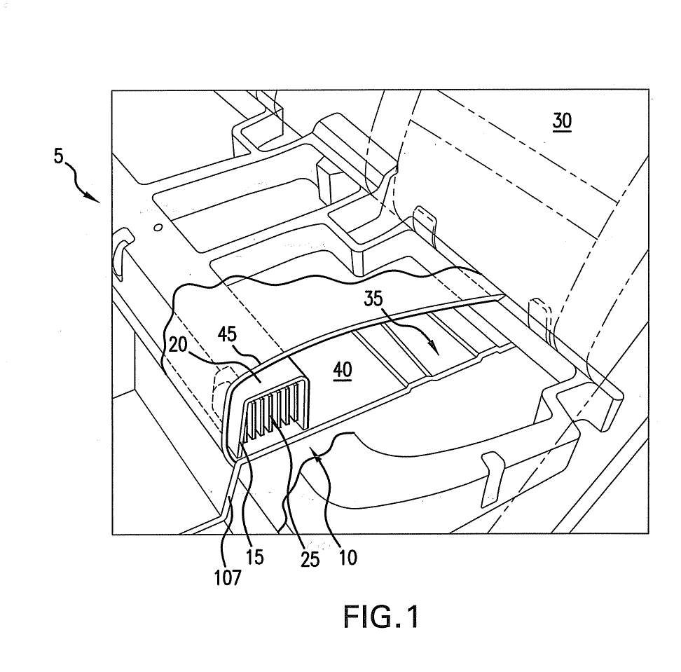

A vehicle seat 5 is illustrated in FIG. 1. The seat 5 includes a cushion carrier 10. The cushion carrier 10 has a frame 15 with a raised front portion 20. Within an interior space of the raised front portion is a rigid and reticulated reinforcement member 25. The reinforcement member 25 includes a plurality of parallel walls or ribs that extend lengthwise in transverse direction, e.g., in a direction oriented from one side of the car to the opposite side of the car. The reinforcement structure 25 may increase the strength of the frame 15. In this regard, the reinforcement structure 25 may dissipate some of the kinetic energy of an occupant exerted onto the frame 15 in the event of crash, e.g., a frontal crash. Thus, the reinforcement structure may limit the possibility of flexing and/or breakage of the frame 15, thus reliably maintaining the raised position of the frame, which may serve to hinder submarining of the occupant during a crash. Although the ribs shown in FIG. 1 are vertical and parallel, it should be appreciated that, according to other examples, the ribs may be slanted so as to be non-vertical and/or angled relative to one another. Moreover, it should be appreciated that, according to other examples, additional walls may be provided that intersect other walls, e.g., to form a lattice or honeycomb structure when viewed in cross-section along in the transverse direction of the vehicle and/or when viewed from above.

The seat 5 has two primary seating positions in order to accommodate two occupants. The raised portion of the frame 15 extends around the sides of the seating positions and along the back of the seating positions below a seat back portion. In this regard, the raised portion extends between the two seats and spans the entire periphery of each of the two seating positions. By extending around the sides of the seating positions, the frame 15 may provide increased lateral, e.g., transverse, support to the occupants, e.g., during cornering or during a side collision. However, it should be appreciated that, according to other examples, the raised portion may be located only at the front of the seat, or any combination of the front of the seat and other regions along the periphery of the seat. It should be further appreciated that while the frame 15 shown in FIG. 1 is a single, integrally formed unit, according to other examples, the frame may be formed in multiple pieces. For example, the left seating position and the right seating position may have separately formed frames and/or each frame may be formed from multiple parts. Although the space between the ribs is open, it should be appreciated that, according to other examples, the ribs may include a filler, e.g., a structural filler such as structural foam. The space may also be suitable for running electrical wiring, ventilation ducts, trunk or hatch-back release cables, etc. The middle portion 35 of each seating position of the frame 15 is capable of accommodating a deeper portion of a molded foam bottom cushion 40 than the raised front portion 20. The middle portion 35 may be open, as shown or, according to other examples, may have a lower support, e.g., a lower panel or webbing, that supports the cushion below the middle 35. A seat trim or cover 45, e.g., fabric or leather is applied over the cushion 40 and secured to the frame 15. The seat 105 is attached to an automobile frame 107 of the automobile.

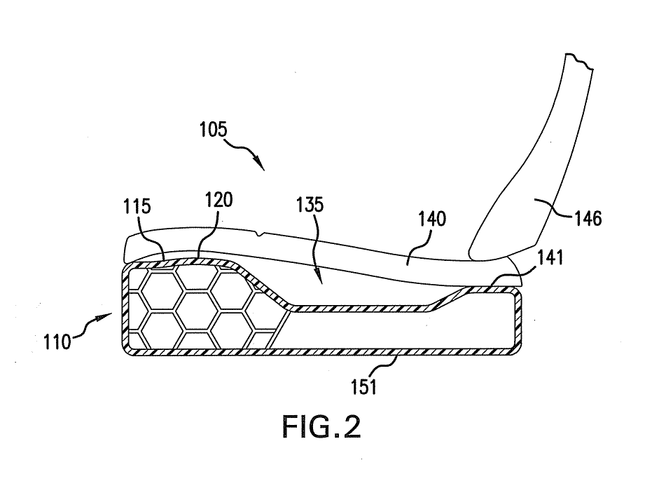

FIG. 2 illustrates a vehicle seat 105 when viewed in cross-section along a transverse axis of the seat 105. The seat 105 includes a cushion carrier 110. The cushion carrier 110 has a frame 115 with a raised front portion 120. Within an interior space of the raised front portion 120 is a rigid and reticulated reinforcement member 125. The reinforcement member 125 includes a honeycomb structure. The cross-section may be constant across at least a majority of the transverse length of the raised front portion 120 or may vary, e.g., the cells of the honeycomb structure may increase or decrease and/or the thickness of the interconnected walls of the honeycomb structure may increase or decrease. Moreover, the honeycomb structure may have a similar cross-section when viewed from above, e.g., if the honeycomb structure is three-dimensional. The honeycomb structure may be formed from any appropriate material, e.g., a rigid plastic, fiberglass, a resin, etc. As with the reinforcement structure 25 illustrated in FIG. 1, the reinforcement structure 125 may increase the strength of the frame 115 and may dissipate some of the kinetic energy of an occupant exerted onto the frame 15 in the event of crash, e.g., a frontal crash. Thus, the reinforcement structure 115 may limit the possibility of flexing and/or breakage of the frame 115, in order to reliably maintain the raised position of the frame, which may serve to hinder submarining of the occupant during a crash. Although the honeycomb structure illustrated in FIG. 2 has straight walls that connect to form a hexagonal cross-section, according to other examples, the honeycomb structure may walls that form other geometric cross-sections, e.g., square or triangular, or may have curved walls, etc. In this regard, the walls may have non-constant thicknesses. The interior space of the honeycomb structure may be open, e.g., filled with gas such as air, or filled, e.g., with a foam such as a rigid structural foam.

A bottom cushion 140, e.g., a molded foam cushion, is disposed above and supported by the cushion carrier 110.

The frame 115 extends beneath the seating position to underlie a middle section 135 of the seating position of the frame 115 to a raised rear portion 141 that extends below a seat back portion 146. The frame 115 has a planar bottom surface 150. As illustrated in cross-section, the frame forms a shell with a wall 151 that extends entirely around the periphery of the cross-section, including the upper surface, bottom surface front surface, and rear surface. Although the reinforcement structure 115 illustrated in FIG. 2 is only located in the vicinity of the raised front portion 120, it should be appreciated that, according to other examples, the reinforcement structure may extend farther, e.g., below the middle portion 135 and/or the portion below the raised back portion 141.

It should be appreciated that other reticulated reinforcement structures may be provided. For example, a structural foam may be applied to the interior space of the raised front portion, with or without additional walls.

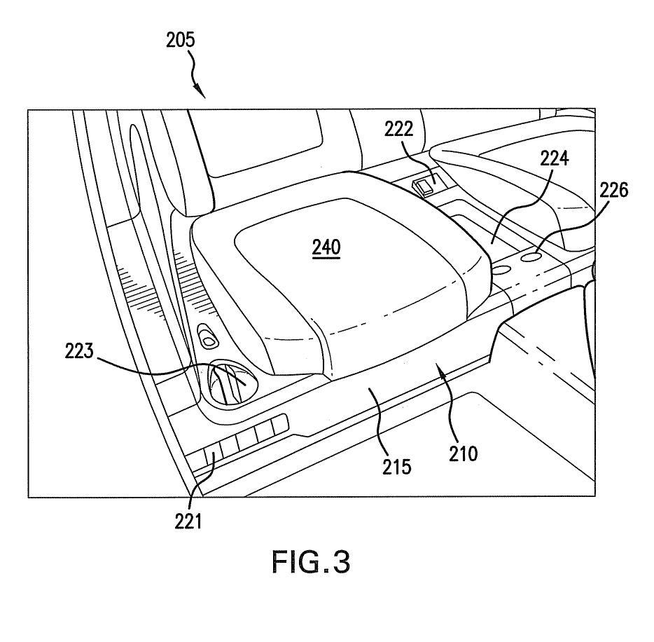

FIG. 3 illustrates a seat 205, which includes a cushion carrier 210 that includes a rigid frame 215. The frame is exposed from a bottom seat cushion 240 that is mounted on and supported by the frame 215. As illustrated, the frame 215 includes outwardly facing surfaces of frame portions that are outwardly exposed from the bottom seat cushion 240. The frame 215 includes a vent 221 that allows air, e.g., from an air conditioning system to transferred from an interior space of the frame 215 to the interior cabin space of the vehicle. The interior space is located behind the exposed portion of the frame 215 adjacent to an inwardly facing surface of the exposed portion. The frame also includes a seatbelt attachment 222. Next to the seat cushion 240 is a cup holder 223 that is integrally formed into the exposed portion of the frame 215 and extends into the interior space of the frame 215. The seat has two seating positions, each having a bottom seat cushion supported by the frame 215. Between the two cushions is a section of the exposed portion. This section includes a storage tray 224 and electronic controls 226, e.g., for an air conditioning system or volume controls for an audio system. The wiring for these controls is disposed below the exposed portion in the interior space of the frame. The exposed portion may be uncovered or covered by, e.g., fabric or leather trim, etc.

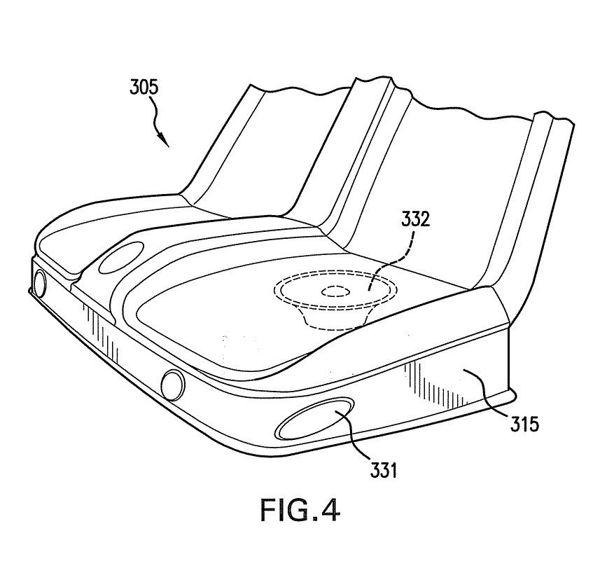

FIG. 4 illustrates a seat 305, which includes an integrated speaker system including speakers 331 that are mounted through an exposed portion of a frame 315, the speaker magnets and wiring disposed within an interior space of the frame 315. The seat also has a subwoofer 332 that is arranged to fire, e.g., into the interior space. In this manner, the interior space acts as an acoustic subwoofer box. According to certain example embodiments, the interior space may be sealed and/or have port holes depending on the desired effect. Although the subwoofer illustrated in FIG. 4 is mounted to fire into the interior space, it should be appreciated that the subwoofer may be mounted to fire away from the interior space, e.g., downwardly.

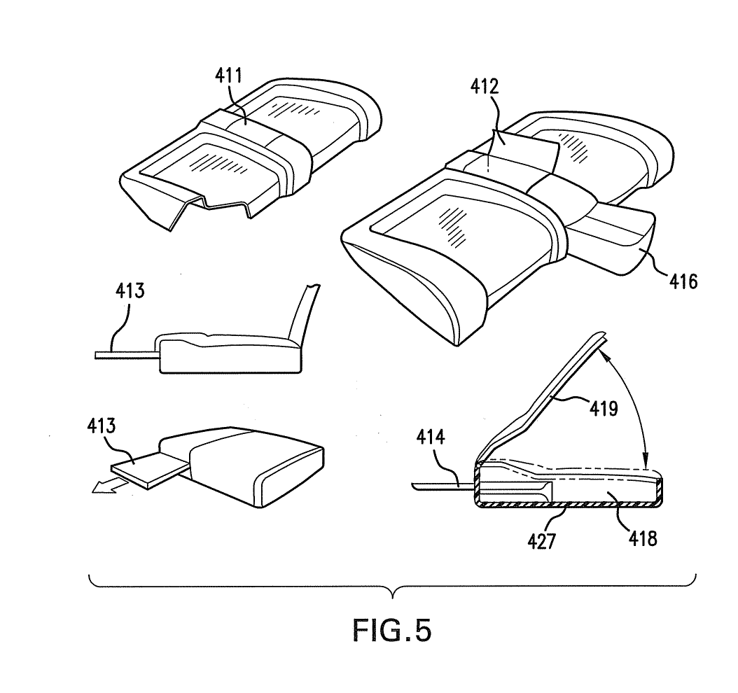

FIG. 5 illustrates various seats. As illustrated, the seats may have a molded-in storage compartment 411 that projects into the interior space of the frame. Storage compartments may be separate components so as to be placed, e.g., removably, into a cutout in the exposed portion of the frame. The storage compartments may have a cover 412. Although the cover illustrated in FIG. 5 is hinged on the side, it should be appreciated that the cover may be hinged on any side and/or completely removable. Trays 413, 414, 416 are also illustrated and are slidable, e.g. on tracks, between an open position, in which the trays may be used by the occupants, and a closed position, in which the trays are at least partially stored within the interior space. The trays may have any appropriate features, e.g., a flat upper surface to support items, or a cup holder. Tray 416 has deep walls, thus forming a storage bin. Tray 414 is slidable into and out of interior space 418. Interior space 418 is accessible by lifting a cushion attachment portion 419 of the frame, which is rotatably attached to a base portion 427 of the frame at a forwardly located pivot. However, it should be appreciated that the pivot may be located at any appropriate location, e.g., the rear or side of the seat. Alternatively or additionally, the cushion attachment portion may be entirely detachable from the base portion.

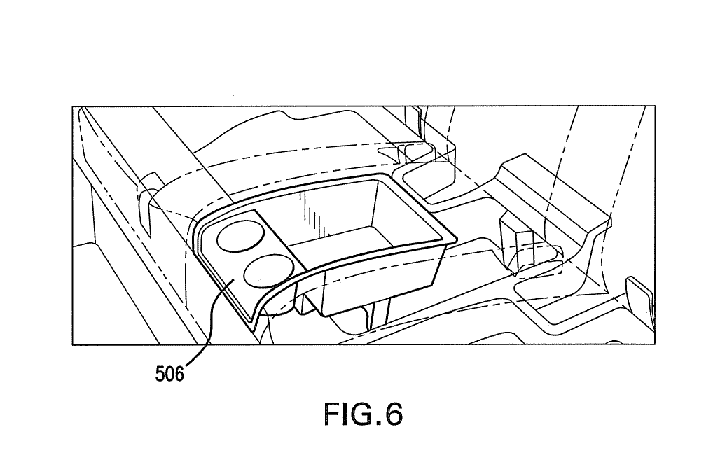

FIG. 6 illustrates a portion of a seat. The seat includes an integrally formed cup-holder and storage unit 506 extending into the interior space of the frame between the two seating positions.

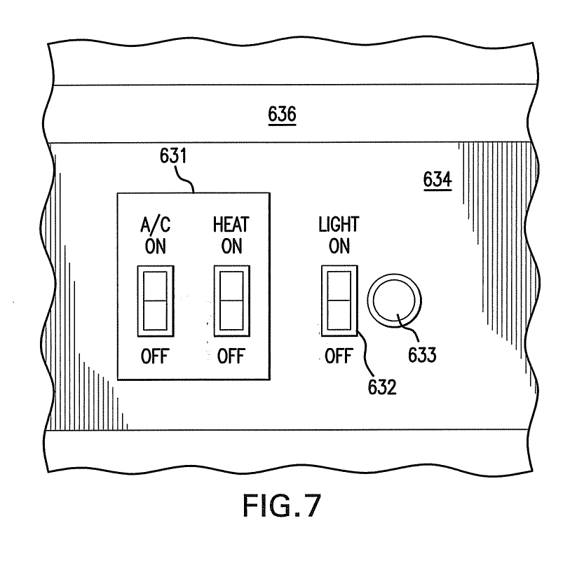

FIG. 7 illustrates a front portion of a seat. The seat includes air conditioning controls 631, a light 633 arranged to illuminate the floor of the vehicle, and a light control 632, each disposed on a front-facing surface 634 of an exposed portion of the frame located below a seat cushion 636, with the electrical wiring for each extending through the interior space of the frame.

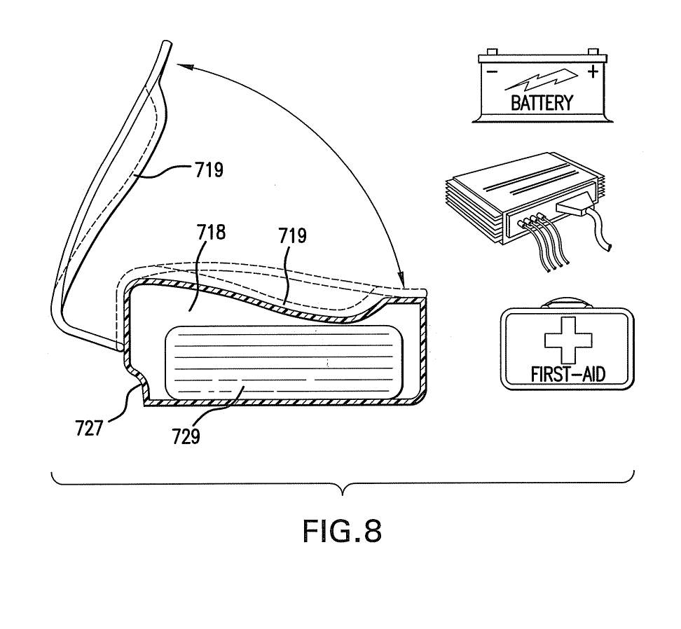

FIG. 8 illustrates a seat, which includes a cushion attachment portion 719 rotatably attached to a base portion 727 at a hinge. The cushion attachment portion 719 may be rotated upwardly to allow access to an interior space 718. A spare tire 729 is stored in the interior space 718 and may be removed through the opening created by rotating the cushion attachment portion 719 upwardly. As illustrated, a variety of other items may be stored in the interior space 718, e.g., a battery, an audio amplifier, a first-aid kit, etc.

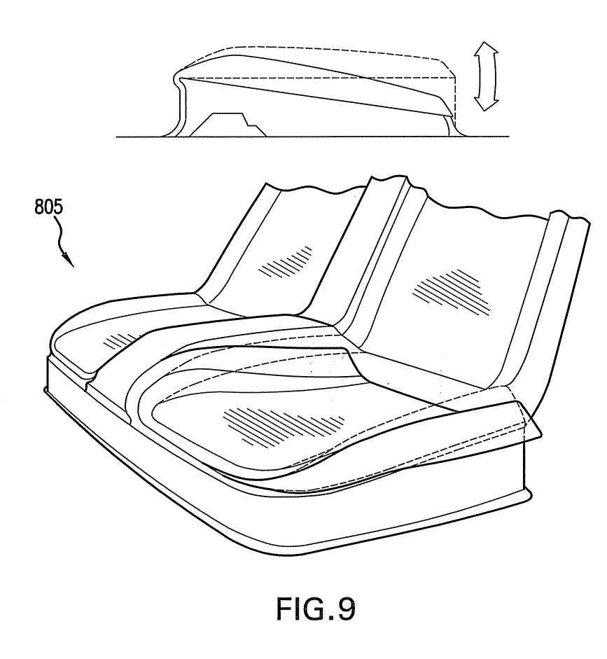

FIG. 9 illustrates an adjustable seat. The seat 805 includes a cushion attachment portion and a base portion of the frame, where the relative angle between the base portion, which is mounted to a vehicle frame, and the cushion attachment portion is variable. This may allow for a variety of seating positions to suit individual preferences.

Each of the cushion carriers described herein may be suitable for providing adequate support to a seat bottom cushion without the necessity of a wire frame. This may provide an economic seating solution, especially when the frame and/or reinforcement member of the cushion carrier are molded from a strong, yet cost-effective material, such as some plastics. Moreover, the cushion carrier may provide a lightweight, integrated support to help prevent submarining, e.g., during crashes.

It should be appreciated that the seats described herein may be utilized at any seating position of a vehicle, e.g., a front, middle, or back seat and may be used in any appropriate kind of vehicle, e.g. an aircraft or a boat.

Although the present invention has been described with reference to particular examples and embodiments, it should be understood that the present invention is not limited to those examples and embodiments. Moreover, the features of the particular examples and embodiments may be used in any combination. The present invention therefore includes variations from the various examples and embodiments described herein, as will be apparent to one of skill in the art.

What is claimed:

1. A seat for a vehicle, comprising:
a cushion carrier for a bottom seat cushion, the carrier including:
a frame with a raised front portion; and
an integrated reinforcement member disposed in an interior space of the front portion, the reinforcement member being rigid and reticulated; and
a molded foam bottom seat cushion disposed above the frame and supported by the frame.

2. The seat according to claim 1, wherein the seat is arranged as a rear seat of a vehicle.

3. The seat according to claim 1, wherein the frame is molded.

4. The seat according to claim 1, wherein the frame is formed from plastic.

5. The seat according to claim 1, wherein the reinforcement member is formed from the same material as the frame.

6. The seat according to claim 1, wherein the reinforcement member includes a plurality of parallel walls.

7. The seat according to claim 6, wherein each wall extends in a transverse direction across the seat.

8. The seat according to claim 1, wherein the reinforcement member includes a honeycomb structure.

9. The seat according to claim 8, wherein the honeycomb structure includes walls that connect to form a hexagonal cross-section.

10. The seat according to claim 1, wherein the reinforcement member is integrally formed with the frame.

11. The seat according to claim 1, wherein the bottom seat cushion is not supported by a wire frame.

12. The seat according to claim 1, wherein the reinforcement member is formed from plastic.

13. The seat according to claim 1, wherein the reinforcement member includes a structural foam.

14. The seat according to claim 1, further comprising a seat cushion covering secured to the seat cushion by attachment to the cushion carrier.

15. The seat according to claim 1, wherein the cushion carrier has a planar bottom surface.

16. The seat according to claim 1, wherein the frame extends to a rear portion of the seat below a seat back portion.

17. The seat according to claim 1, wherein the frame includes at least one raised side portion.

18. The seat according to claim 1, wherein the seat has two seating positions arranged to accommodate two occupants, and wherein the frame supports both seating positions.

19. The seat according to claim 18, wherein the frame is integrally formed as a single piece.

20. The seat according to claim 19, wherein the frame includes a raised center portion that extends between the two seating positions.

21. A vehicle comprising:
a seat including:
a cushion carrier for a bottom seat cushion, the carrier having:
a frame with a raised front portion; and
an integrated reinforcement member disposed in an interior space of the front portion, the reinforcement member being rigid and reticulated; and
a molded foam bottom seat cushion disposed above the frame and supported by the frame.

22. The vehicle according to claim 21, wherein the vehicle is an automobile.

23. The vehicle according to claim 22, further comprising an automobile frame, wherein the frame of the cushion carrier is attached directly to the automobile frame.
